(19) United States
(12) Patent Application Publication
(10) Pub. No.: US 2022/0279027 A1
(43) Pub. Date: Sep. 1, 2022

(54) METHOD AND SYSTEM FOR DIGITAL CONTENT TRANSFER

(71) Applicant: RAKUTEN MOBILE, INC., Tokyo (JP)

(72) Inventors: Tarun BHARDWAJ, Bengaluru (IN); Devesh GAUTAM, Tokyo (JP)

(73) Assignee: RAKUTEN MOBILE, INC., Tokyo (JP)

(21) Appl. No.: 17/537,826

(22) Filed: Nov. 30, 2021

Related U.S. Application Data
(60) Provisional application No. 63/154,824, filed on Mar. 1, 2021.

(51) Int. Cl. H04L 65/60; H04L 65/612; H04L 67/568

(52) U.S. Cl. CPC H04L 65/605; H04L 65/4084; H04L 67/2842; H04L 65/80

(57) ABSTRACT

A system and method for providing digital content and caching digital content. Digital content that has not been played back within a first time period is identified in a random-access memory. The random-access memory is associated with an edge node of a content delivery network. The digital content that has not been played back within the first time period is transferred to a storage device associated with a middle-tier node of the content delivery network. Digital content in the storage device of the middle-tier node that has not been played back within a second time period is transferred to an external storage device. The external storage device is associated with an external node of the content delivery network.

### BACKGROUND

A content delivery network (“CDN”) is a geographically distributed network of cache servers that deliver content to end users. CDN nodes may be deployed in multiple locations. Requests for content may be directed to nodes that are in an optimal location for the requesting end users. CDNs were created to alleviate some of the workload from the Internet. CDNs heretofore serve as a layer of the Internet that provides many different types of digital content to users including, but not limited to, web objects, downloadable files, applications, streaming media, and the like.

### BRIEF DESCRIPTION OF THE DRAWINGS

FIG. 1 is an example apparatus in accordance with aspects of the present disclosure.

FIG. 2 is an example system in accordance with aspects of the present disclosure.

FIG. 3 is an example method in accordance with aspects of the present disclosure.

FIG. 4 is a working example in accordance with aspects of the present disclosure.

FIG. 5 is a further example method in accordance with aspects of the present disclosure.

FIG. 6 is yet another example method in accordance with aspects of the present disclosure.

FIG. 7 is further example in accordance with aspects of the present disclosure.

FIG. 8 is an example of a system in accordance with aspects of the present disclosure.

FIG. 9 is a further example method in accordance with aspects of the present disclosure.

FIGS. 10-12 illustrate a further working example in accordance with aspects of the present disclosure.

### DETAILED DESCRIPTION

As noted above, a CDN is a geographically distributed network of cache servers that provide low-latency access to digital content such as media content or a web page. Therefore, rather than making multiple requests to an origin server, which is situated at the Internet service provider's location, the content may be redundantly cached in different locations. In a CDN, the cache servers expedite delivery by being within geographic proximity of end users and by avoiding contact with a distant origin server.

While CDN offers many advantages, there are some notable drawbacks. For example, random access memory (“RAM”) in a cache server of a CDN has a limited capacity (e.g., 100 GB). Therefore, once the cache is at full capacity, additional content cannot be accommodated without deleting other content. CDNs may use a “least used content” approach for managing cache capacity (i.e., content that is used the least is deleted). However, multiple requests for deleted content may curb overall performance of the system, given that the cache server may have to retrieve the deleted content from an origin server that is not within a reasonable geographic proximity of a large group of users.

In view of the foregoing, disclosed herein are a system and method for caching digital content in a cloud environment. Cloud systems may auto scale when RAM resources are exhausted by launching a new server or virtual machine. Such a system may allow least used content to remain in RAM indefinitely without deletion. However, this may lead to a suboptimal allocation of new servers. A surge of least used content may occupy valuable RAM space. As such, a proper caching technique may be needed to ensure that the cloud system scales optimally based on frequently used content such that RAM occupancy of least used content is kept to a minimum. Nevertheless, simple deletion of least used content from RAM is not desirable for the reasons discussed above (i.e., numerous requests for deleted content may hinder performance due to the inconvenient geographic location of the origin server).

In one aspect, a method executed by at least one processor may include the following operations: identifying, in a random-access memory, digital content that has not been played back within a first time period, where the random-access memory is associated with an edge node of a content delivery network; transferring the digital content that has not been played back within the first time period to a storage device, where the storage device is associated with a middle-tier node of the content delivery network; identifying, in the storage device, digital content that has not been played back within a second time period; and, transferring the digital content that has not been played back within the second time period to an external storage device, where the external storage device is associated with an external node of the content delivery network. The edge node, middle-tier node, and the external node may be in the same geographic location.

In a further aspect, transferring the digital content that has not been played back within the first time period may further include converting the digital content into a file that is compatible with the storage device and the external storage device. In yet a further aspect, the method may include identifying digital content in the external storage device that has not been played back within a third time period, and deleting from the external storage device the digital content that has not been played back within the third time period.

In another example, the first time period, the second time period, and the third time period are configurable. Also, the edge node, the middle-tier node, and the external node may be virtual machines executing on a single host machine. However, the edge node, the middle-tier node, and the external node may also be arranged to execute on a separate, respective host machine.

In yet another example, the method may include the following operations: receiving a digital content request; determining that the requested digital content is not stored in the random-access memory associated with the edge node; and forwarding the digital content request to the middle-tier node.

The method may also include determining that the requested digital content is not in the storage device associated with the middle-tier node; and forwarding the digital content request to the external node.

In one example, the method may also include: determining that the requested digital content is not in the storage device associated with the middle-tier node; determining that the requested digital content is not in the external storage device associated with the external node; and, forwarding the digital content request to an origin server containing a repository of digital content.

In another aspect, the method may include determining that a performance metric is below a threshold, wherein the performance metric is at least partially based on time between receiving a digital content request and responding to the digital content request; and generating at least one additional edge node such that the performance metric meets or exceeds the threshold.

Also disclosed is a system that may include a random-access memory and at least one processor. The at least one processor may be configured to carry out the following operations: identify, in the random-access memory, digital content that has not been played back within a first time period, where the random-access memory is associated with an edge node of a content delivery network; transfer the digital content that has not been played back within the first time period to a storage device, where the storage device is associated with a middle-tier node of the content delivery network; identify, in the storage device, digital content that has not been played back within a second time period; and transfer the digital content that has not been played back within the second time period to an external storage device, where the external storage device is associated with an external node of the content delivery network.

In a further aspect, the at least one processor may also be configured to convert the digital content that has not been played back within the first time period into a file that is compatible with the storage device and the external storage device. In another example, at least one processor may be configured to identify digital content in the external storage device that has not been played back within a third time period; and, delete from the external storage device the digital content that has not been played back within the third time period.

In yet another example, the at least one processor is further configured to receive a digital content request; determine that the requested digital content is not stored in the random-access memory associated with the edge node; and forward the digital content request to the middle-tier node. In another example, the at least one processor is further configured to: determine that the requested digital content is not in the storage device associated with the middle-tier node; and forward the digital content request to the external node.

In a further example, the at least one processor is further configured to: determine that the requested digital content is not in the storage device associated with the middle-tier node; determine that the requested digital content is not in the external storage device associated with the external node; and, forward the digital content request to an origin server containing a repository of digital content.

In yet another aspect, the at least one processor of the system may be further configured to: determine that a performance metric is below a threshold, where the performance metric is at least partially based on time between receiving a digital content request and responding to the digital content request; and generate at least one additional edge node such that the performance metric meets or exceeds the threshold.

Aspects features and advantages of the present disclosure will be appreciated when considered with reference to the following description of examples and accompanying figures. The following description does not limit the application; rather, the scope of the disclosure is defined by the appended claims and equivalents.

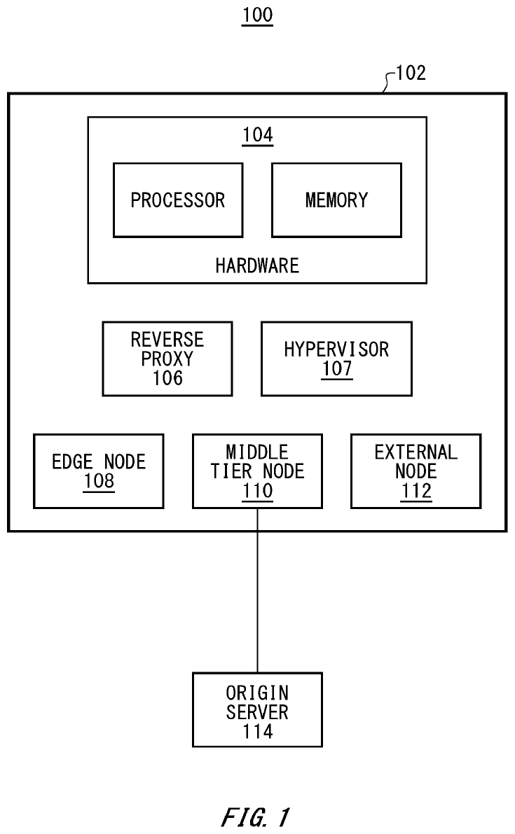

FIG. 1 presents a schematic diagram of an illustrative computer apparatus 100 for executing the techniques disclosed herein. Computer apparatus 100 may comprise any device capable of processing instructions and transmitting data to and from other computers, including a laptop, a full-sized personal computer, a high-end server, or a network computer lacking local storage capability. Computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network.

The computer apparatus 100 may also contain hardware 104 such as processors and memory devices. In another example, the processors may be application specific integrated circuits (“ASICs”) or field-programmable gate arrays (“FPGAs”). The memory may be random-access memory (“RAM”) devices divided into multiple memory segments organized as dual in-line memory modules (“DIMMs”). The memory may store instructions that may be retrieved and executed by one or more processors. The memory may also store digital content that may be retrieved by users. While only one processor and one memory are shown in FIG. 1, computer apparatus 100 may comprise additional processors and memories that may or may not be stored within the same physical housing or location.

FIG. 1 also illustrates a hypervisor 107 that may instruct the processors to launch one or more virtual machines within apparatus 100. In the example of FIG. 1, edge node 108, middle-tier node 110, external node 112, and reverse proxy 106 may be executed as virtual machines that are launched and monitored by hypervisor 107. Hypervisor 107 may allocate a predefined level of processing and memory resources to these virtual machines. Hypervisor 107 may be a bare metal or hosted hypervisor. A bare metal hypervisor may be a lightweight operating system that may run directly on the hardware of apparatus 100. A hosted hypervisor may execute as a software layer on an operating system of apparatus 100. Apparatus 100 may be one of many apparatuses at a data center.

In one example, reverse proxy 106 may instruct one or more processors to monitor delivery of content and scale when needed. Reverse proxy 106 may serve as an intermediary between end users and edge node 108. Edge node 108 may reply to requests for digital content as will be discussed further below. Middle-tier node 110 and external node 112 may cache certain digital content as will also be discussed below. Middle-tier node 110 may be in communication with origin server 114 in the event certain digital content cannot be found in any of the nodes.

The instructions for carrying out the techniques discussed herein may comprise any set of instructions to be executed directly (such as machine code) or indirectly (such as scripts) by a processor or multiple processors. In this regard, the terms “instructions,” “scripts,” or “modules” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

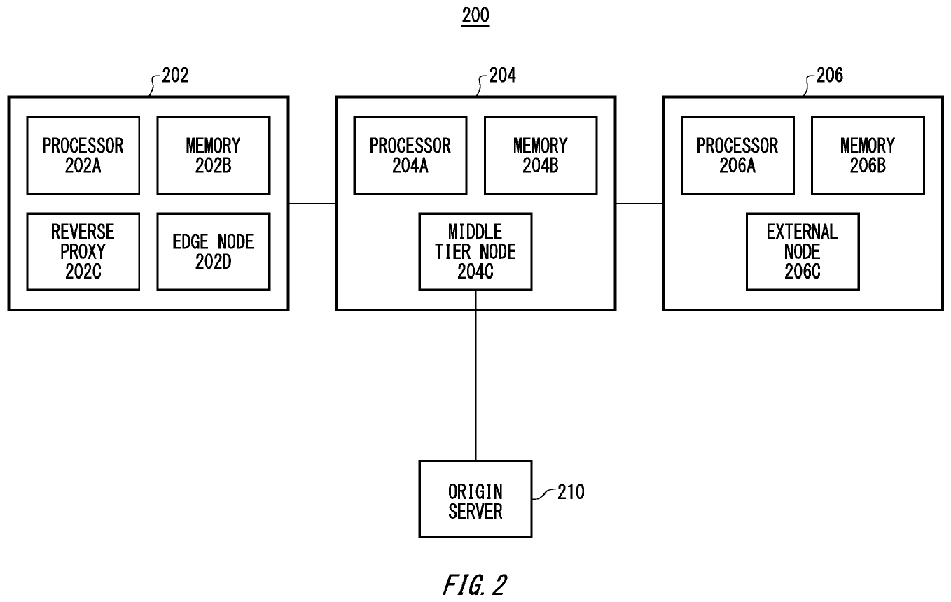

Although all the components of computer apparatus 100 are functionally illustrated as being within the same apparatus 100, it will be understood that the components may or may not be stored within the same physical housing. As mentioned above, apparatus 100 may be one of many located in a data center. For example, turning now to FIG. 2, an example topology 200 is shown. In this example, apparatus 202, 204, and 206 may be in network communication. Apparatus 202 is shown with a processor 202A, memory 202B, reverse proxy 202C, and edge node 202D; apparatus 204 is shown with a processor 204A, memory 204B, and middle-tier node 204C; apparatus 206 is shown with a processor 206A, memory 206B, and external node 206C; Apparatus 204 is shown in communication with origin server 210. Each of the computers shown in FIG. 2 may also execute a hypervisor that may launch proxy servers and edge nodes as virtual machines. Although only a few computers are depicted herein it should be appreciated that a network may include additional interconnected computers and that FIG. 2 shows only three computers for illustrative purposes. Furthermore, it is understood that the nodes may be arranged differently within the apparatus machines shown in FIG. 2. For example, apparatus 202 could host an edge node and a middle-tier node while apparatus 206 hosts an external node. Also, origin server may be in communication with the edge node rather than the middle-tier node. As such, it is understood that many different arrangements may be devised to carry out the techniques discussed in the present disclosure.

A data center and may be reachable via a local area network (“LAN”), wide area network (“WAN”), the Internet, etc. Such a data center may be geographically distributed to minimize latency. Therefore, for example, the edge node 202D, shown in FIG. 2 may deliver digital content to users within its proximity. The networked apparatus shown in FIG. 2 may amount to a data center network architecture that includes, but is not limited to, tree-based topology, multistage circuit-switching network, or a DCell architecture.

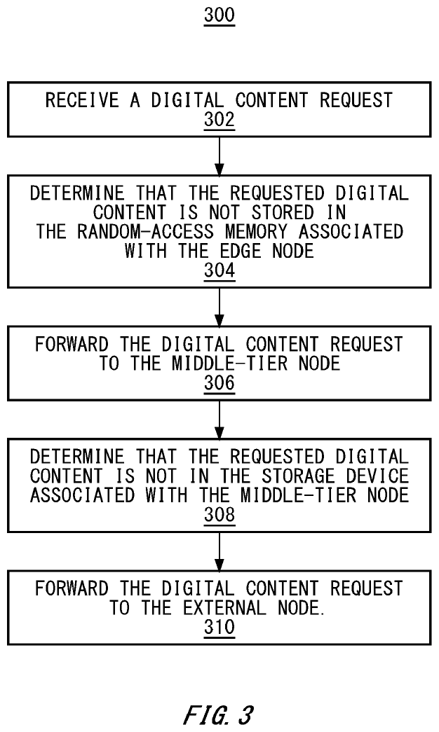

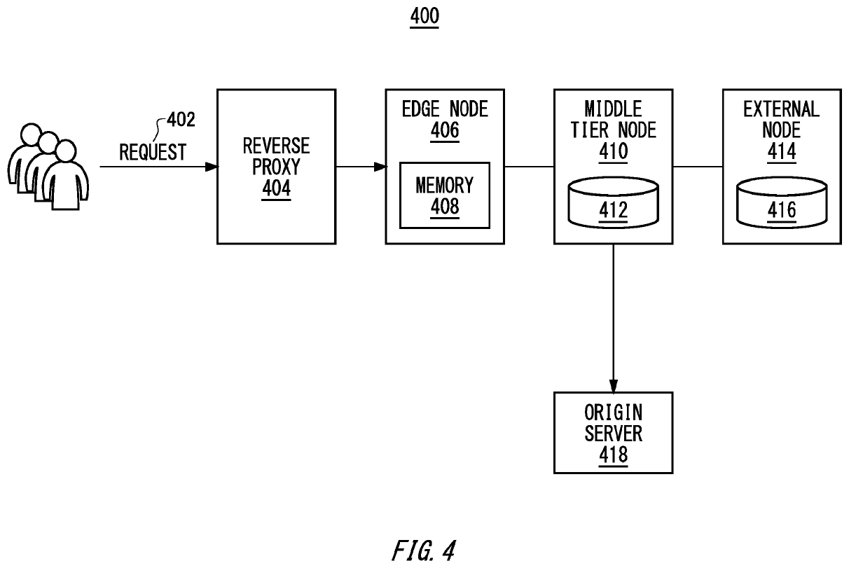

FIG. 3 is an example method 300 for responding to digital content requests in accordance with aspects of the disclosure. FIG. 4 is a working example 400 that corresponds to FIG. 3. Both figures will be discussed jointly below. In block 302 of FIG. 3, a digital content request may be received. Referring to FIG. 4, digital content request 402 is shown being received by reverse proxy 404 which forwards the request to edge node 406. Referring to FIG. 3, it may be determined that the requested digital content is not stored in the RAM associated with the edge node, as shown in block 304. In FIG. 4, edge node 406 may determine that the requested digital content is not in RAM 408. In FIG. 3, the request may be forward to the middle-tier node, as shown in block 306. In block 308, it may be determined that the requested digital content is not in a storage device associated with the middle-tier node. In turn, the content request may be forwarded to the external node, as shown in block 310. Referring to FIG. 4, middle-tier node 410 may determine that the requested content is not in storage 412. In this case, middle-tier node 410 may forward the request to external node 414. The external node 414 may have an external storage device 416.

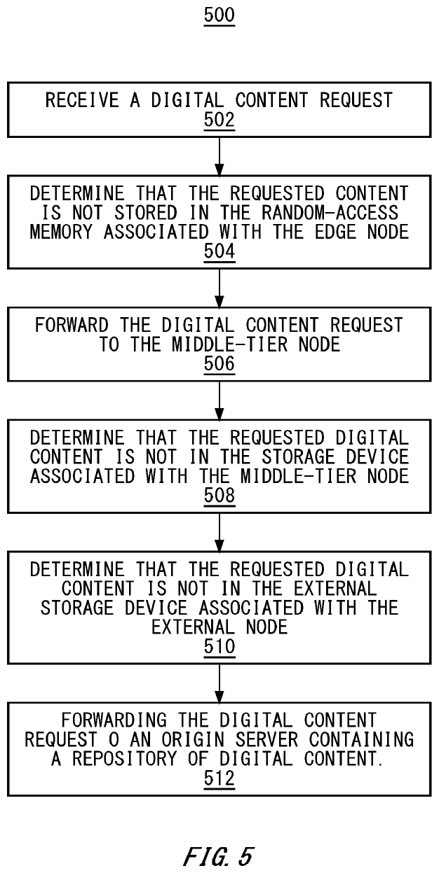

FIG. 5 is an alternate method 500 for responding to digital content requests in accordance with aspects of the disclosure. In block 502, a digital content request may be received; in block 504, it may be determined that the digital content request is not in a RAM associated with an edge node; in block 506, the request may be forwarded to a middle-tier node; in block 508, it may be determined that the requested digital content is not in a storage device associated with a middle-tier node; in block 510 it may be determined that the requested digital content is not in an external storage device associated with an external node. The digital content request may then be forwarded to an origin server containing a repository of digital content, as shown in block 512.

Referring to FIG. 4, middle-tier node 410 is shown to be in communication with origin server 418. In one example, origin server 418 may be at a location that is geographically inconvenient, but it may also be optimally distributed. If the content is not contained in external storage device 416, origin server 418 may be the last resort. That is, the origin server may be the last resort, if the digital content is not located in the edge node 406, middle-tier node 410, or external node 414.

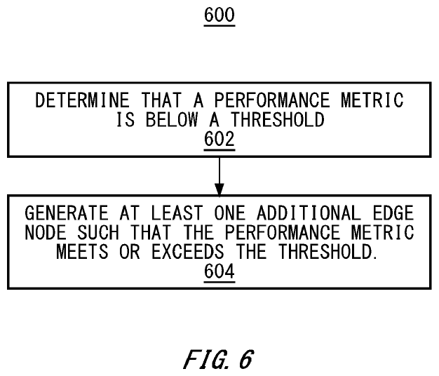

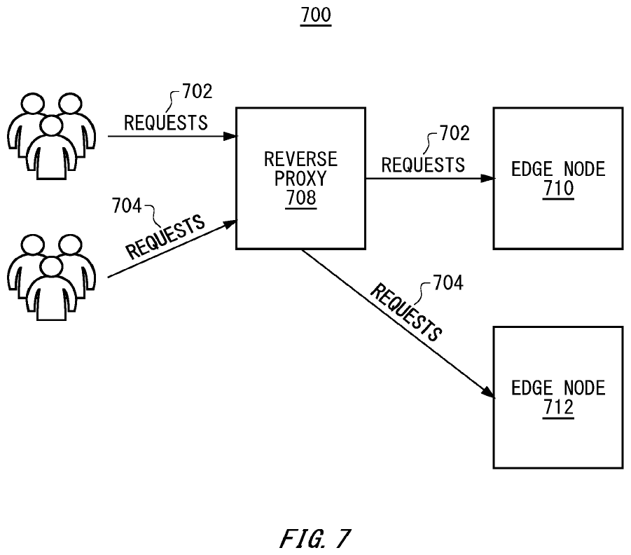

Referring now to FIG. 6, FIG. 6 depicts an example method 600 for scaling to maintain performance. FIG. 7 is a working example 700 that corresponds to FIG. 6 and both figures will be discussed jointly. In block 602 of FIG. 6, it may be determined that a performance metric is below a threshold. Referring to FIG. 7, users may send requests 702 and 704 to reverse proxy 708. Reverse proxy 708 may forward that request to edge node 710. Reverse proxy 708 may determine that the performance of the system is below a threshold. In one example, the performance metric may be at least partially based on time between receiving a digital content request and responding to the digital content request. Reverse proxy 708 may monitor these times to ensure that the users are receiving their digital content at a rate that is within the performance threshold. Referring now to FIG. 6, at least one additional edge node may be generated such that the performance metric meets or exceeds the threshold, as illustrated in block 604. In FIG. 7, in the event that the performance does not meet this threshold another edge node instance may be generated. This additional edge node 712 may be generated as another virtual machine by a hypervisor. Reverse proxy 708 may send a request to the hypervisor to generate an additional edge node instance. Reverse proxy 708 is shown forwarding the requests 704 to the new edge node 712. In another example, edge node 710 and edge node 712 may executed in the same host machine or may be executed on separate host machines.

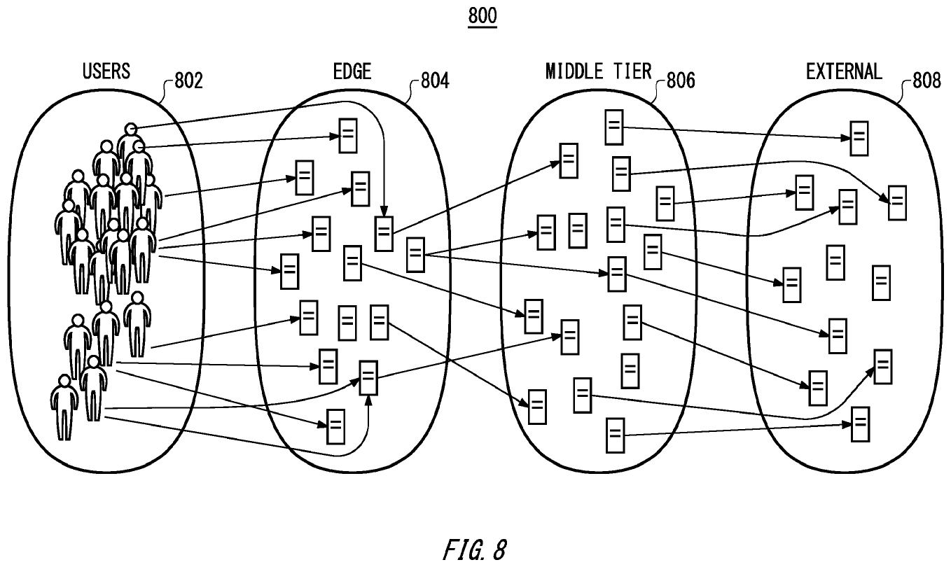

Referring now to FIG. 8, a high-level depiction of a CDN 800 is shown. Users 802 may send digital content requests to edge nodes 804. As noted above, the edge nodes may be geographically located such that latency is minimized. A respective edge node in edge nodes 804 may forward requests to a respective middle-tier node in middle-tier nodes 806 if the digital content request cannot be found in an edge node server. If a respective middle-tier node cannot fill the digital content request, the request may be forwarded to a respective external node in the external nodes 808 group. As noted above, if the content is not found in any of these nodes, a request may be forwarded to an origin server containing a repository of all digital content. As also noted above, the edge nodes 804, middle-tier nodes 806, and external nodes 808 may be housed at a data center that is proximal to the users 802. In another example, edge nodes 804 may be housed nearest to the users 802 and middle-tier nodes 806 and external nodes 808 may be housed at a location that is further away from users 802. However, it is understood that various arrangements may be implemented and that the example of FIG. 8 is merely illustrative.

As noted above, the system disclosed herein may make the first attempt to fill a digital content request from the RAM resources of an edge node. If the digital content is found in the edge node's RAM, the performance may be most favorable to the users given that the edge nodes are at a geographical location that is proximal to the users and that RAM access is efficient. The middle-tier nodes and the external nodes may also be geographically proximal to the users. However, the digital content of the middle-tier and external nodes are not in RAM so the performance may not be as desirable as that of the edge node, but still may be at a reasonable level of performance. Notwithstanding the favorable performance of the edge node, as noted earlier, the amount of RAM contained in the edge node is limited. It is not likely that the edge node's RAM may retain every conceivable item of digital content that a user may request. In view of this, a system for caching digital content may be needed.

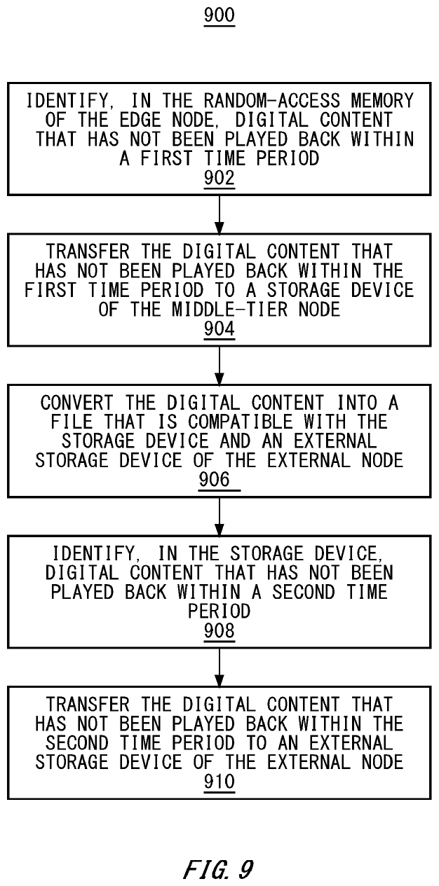

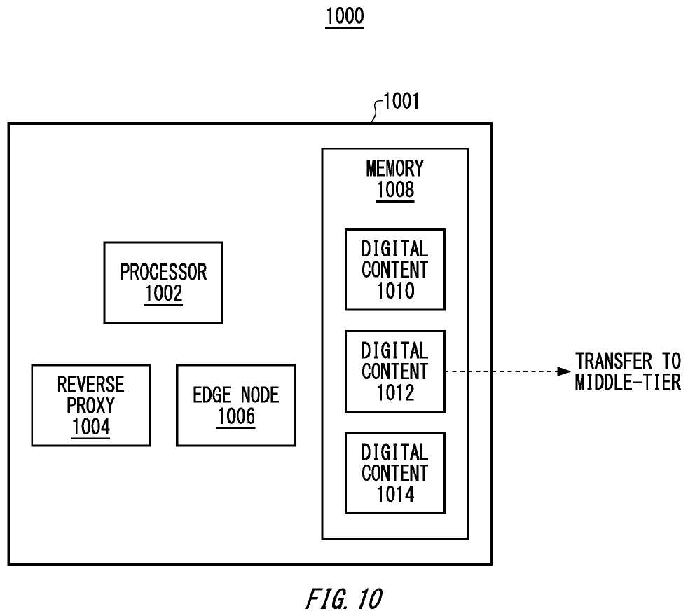

Working examples of the caching system and method are shown in FIGS. 9 through 12. FIG. 9 illustrates a flow diagram of an example method 900 for caching digital content in a content delivery network. FIGS. 10-12 show working examples 1000, 1100, and 1200 respectively, all of which are in accordance with the techniques disclosed herein. The actions shown in FIGS. 10-12 will be discussed below with regard to the flow diagram of FIG. 9.

Referring to FIG. 9, digital content in RAM that has not been played back within a first time period may be identified, as shown in block 902. The RAM may be associated with an edge node. Referring now to FIG. 10, an example apparatus 1001 is shown. The apparatus is shown having a processor 1002, which may also comprise multiple processors, and a RAM 1008. The RAM 1008 may contain various digital content items. In the example of FIG. 10, RAM 1008 contains digital content item 1010, digital content item 1012, and digital content item 1014. However, it is understood that RAM may contain many more items of digital content and that the example of FIG. 10 is merely illustrative. In the example of FIG. 10, apparatus 1001 may be one server in a data center housing many servers that are equipped to reply to digital content requests. By way of example, reverse proxy 1004 may instruct processor 1002 that digital content item 1012 has not been played back within a first time period. Alternatively, a separate process may execute periodically to identify digital content that has not been accessed within a first time period. For example, in a UNIX environment, a cron job may be scheduled to identify digital content that has not been accessed within a first time period. The first time period may be configurable and may be, for example, two hours. In this instance, any item of digital content that has not been accessed for more than two hours may be identified as not being accessed within the first time period.

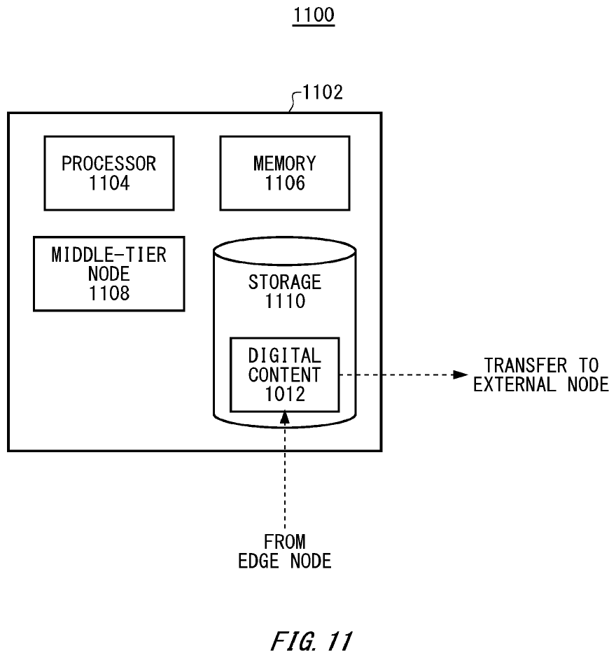

Referring to FIG. 9, digital content that has not been played back within the first time period may be transferred to a storage device associated with the middle-tier node, as shown in block 904. Referring to FIG. 10, as noted above, processor 1002 may determine that no users have played back digital content item 1012 for more than the first time period. In this case, digital content item 1012 may be transferred to the middle-tier node shown in FIG. 11.

FIG. 11 shows an apparatus 1102 that may contain a middle-tier node 1108, a processor 1104, a memory 1106 and a storage device 1110. The storage device 1110 may store the digital content item 1012. Storage device 1110 may be arranged as a private cloud storage, public cloud storage or a hybrid cloud storage.

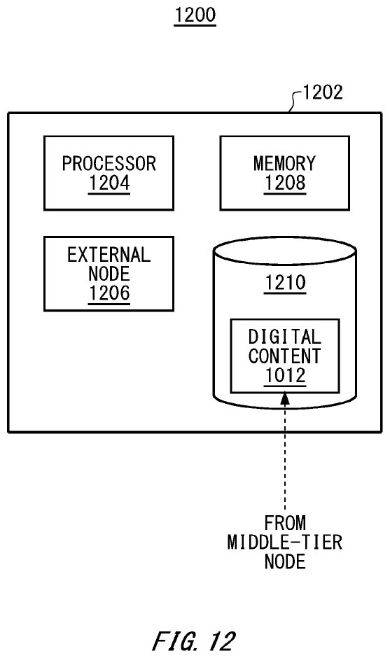

Referring to block 906 of FIG. 9, the digital content may be converted into a file that is compatible with a storage device, such as storage device 1110 and external storage device 1210 associated with external node 1206 of FIG. 12. The conversion may include converting the digital content from RAM into a file that is in accordance with a file hierarchy. Alternatively, the digital content may be stored in the edge node's RAM and the edge node's permanent storage. In the event the digital content needs to be moved to the middle-tier node, the copy of the digital content from the edge node's permanent storage device may be copied to the middle-tier node.

In block 908, it may be determined that the digital content has not been played back within a second time period. In FIG. 11, the processor 1104 may also determine that digital content 1012 has not been accessed for a second time period. As with the first time period, the second time period may also be configurable. In one example, the second time period may be seven days.

Referring now to block 910 of FIG. 9, the digital content that has not been played back within the second time period may be transferred to an external storage device associated with an external node. The external storage device may also be a private cloud, public cloud, or hybrid storage. By way of example, FIG. 11 shows digital content item 1012 being transferred to apparatus 1202 in FIG. 12. Apparatus 1202 may have a processor 1204, a memory 1208, an external node 1206, and an external storage device 1210. Digital content item 1012 may be stored in external storage device 1210 for a third time period. This third time period may also be configurable and may be, for example, thirty days.

In another example, it may be determined that that digital content has not been accessed within the third time period (e.g., thirty days). In this instance the digital content may be deleted from the external node. In the event that a user requests the deleted digital content again in the future, the system may retrieve the digital content from the origin server. Therefore, digital content that is least popular may be moved further down the cache hierarchy.

Advantageously, the above-described system and method provides a scalable system that allows high demand digital content to be readily accessible. The above system may use a cloud approach that scales when RAM resources are exhausted. As noted above, when RAM resources are exhausted, a new edge node server may be launched. The new edge node server may be launched as a virtual machine by a hypervisor. The above-described system and method also removes content from RAM when it is determined that the content has not been accessed for a configurable amount of time. This may lead to an optimal allocation of new edge node servers such that the most popular content occupies the edge node's valuable RAM space. Meanwhile, content that is not as popular may be place in a storage device of a middle-tier or external node. As noted above, RAM may be the most efficient way to access the digital content while permanent storage devices in the other tiers may not be as efficient.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. A method executed by at least one processor, the method comprising:
identifying, in a random-access memory, digital content that has not been played back within a first time period, wherein the random-access memory is associated with an edge node of a content delivery network;
transferring the digital content that has not been played back within the first time period to a storage device, wherein the storage device is associated with a middle-tier node of the content delivery network;
identifying, in the storage device, digital content that has not been played back within a second time period; and,
transferring the digital content that has not been played back within the second time period to an external storage device, wherein the external storage device is associated with an external node of the content delivery network.

2. The method of claim 1, wherein transferring the digital content that has not been played back within the first time period further comprises converting the digital content into a file that is compatible with the storage device and the external storage device.

3. The method of claim 1, further comprising:
identifying digital content in the external storage device that has not been played back within a third time period; and,
deleting from the external storage device the digital content that has not been played back within the third time period.

4. The method of claim 3, wherein the first time period, the second time period, and the third time period are configurable.

5. The method of claim 1, wherein the edge node, the middle-tier node, and the external node are virtual machines executing on a single host machine.

6. The method of claim 1, wherein the edge node, the middle-tier node, and the external node each execute on a separate host machine.

7. The method of claim 1, further comprising:
receiving a digital content request;
determining that the requested digital content is not stored in the random-access memory associated with the edge node; and
forwarding the digital content request to the middle-tier node.

8. The method of claim 7, further comprising:
determining that the requested digital content is not in the storage device associated with the middle-tier node; and
forwarding the digital content request to the external node.

9. The method of claim 7, further comprising:
determining that the requested digital content is not in the storage device associated with the middle-tier node;
determining that the requested digital content is not in the external storage device associated with the external node; and,
forwarding the digital content request to an origin server containing a repository of digital content.

10. The method of claim 1, further comprising:
determining that a performance metric is below a threshold, wherein the performance metric is at least partially based on time between receiving a digital content request and responding to the digital content request; and
generating at least one additional edge node such that the performance metric meets or exceeds the threshold.

11. A system comprising:
a random-access memory;
at least one processor configured to:
identify, in the random-access memory, digital content that has not been played back within a first time period, wherein the random-access memory is associated with an edge node of a content delivery network;
transfer the digital content that has not been played back within the first time period to a storage device, wherein the storage device is associated with a middle-tier node of the content delivery network;
identify, in the storage device, digital content that has not been played back within a second time period; and,
transfer the digital content that has not been played back within the second time period to an external storage device, wherein the external storage device is associated with an external node of the content delivery network.

12. The system of claim 11, wherein the at least one processor is further configured to convert the digital content that has not been played back within the first time period into a file that is compatible with the storage device and the external storage device.

13. The system of claim 11, wherein the at least one processor is further configured to:
identify digital content in the external storage device that has not been played back within a third time period; and,
delete from the external storage device the digital content that has not been played back within the third time period.

14. The system of claim 13, wherein the first time period, the second time period, and the third time period are configurable.

15. The system of claim 11, wherein the edge node, the middle-tier node, and the external node are virtual machines executing on a single host machine.

16. The system of claim 11, wherein the edge node, the middle-tier node, and the external node each execute on a separate host machine.

17. The system of claim 11, wherein the at least one processor is further configured to:
receive a digital content request;
determine that the requested digital content is not stored in the random-access memory associated with the edge node; and
forward the digital content request to the middle-tier node.

18. The system of claim 17, wherein the at least one processor is further configured to:
determine that the requested digital content is not in the storage device associated with the middle-tier node; and
forward the digital content request to the external node.

19. The system of claim 17, wherein the at least one processor is further configured to:
determine that the requested digital content is not in the storage device associated with the middle-tier node;
determine that the requested digital content is not in the external storage device associated with the external node; and,
forward the digital content request to an origin server containing a repository of digital content.

20. The system of claim 11, wherein the at least one processor is further configured to:
determine that a performance metric is below a threshold, wherein the performance metric is at least partially based on time between receiving a digital content request and responding to the digital content request; and
generate at least one additional edge node such that the performance metric meets or exceeds the threshold.
